(19) United States
(12) Patent Application Publication
(10) Pub. No.: US 2003/0073246 A1
(43) Pub. Date: Apr. 17, 2003

(54) Triangular combinatorial chemchip and its preparation

(75) Inventors: Jack Ting, Hsinchu (TW); Ren-Jye Wu, Hsinchu (TW); Wen-Hsuan Chao, Hsinchu (TW); Tien-Heng Huang, Hsinchu (TW)

Correspondence Address: SUGHRUE MION, PLLC, 2100 PENNSYLVANIA AVENUE, N.W., WASHINGTON, DC, 20037, US

(73) Assignee: INDUSTRIAL TECHNOLOGY RESEARCH INSTITUTE

(21) Appl. No.: 10/160,030

(22) Filed: Jun. 4, 2002

(30) Foreign Application Priority Data
Oct. 17, 2001 (TW) 90125667

(51) Int. Cl. G01N 1/10

(52) U.S. Cl. 436/180; 422/55; 422/102

(57) ABSTRACT

A triangular combinatorial chemchip and its preparation method are disclosed. Such a triangular combinatorial chemchip is a systematically arrangement of distinct defined regions formed by combinatorially sputtering with masks on the surface of a substrate. This arrangement coordinates compositions or concentrations of different species inside the chip. By using such triangular chemchips, one can quickly and efficiently screen adequate compositions and recipes of sample materials.

### BACKGROUND OF THE INVENTION

1. Field of the Invention

The present invention relates to a combinatorial chemical chip and its preparation. More particularly, it relates to a triangular combinatorial chemical chip which defines an arrangement to coordinate the compositions of species, and its preparation.

2. Description of the Related Arts

A combinatorial chemical chip is a chip, featuring a large number of sample materials of different compositions arranged on a small region. By analyzing and comparing the differences in expression among sample materials, a user can screen out better or more adequate compositions as needed.

WO 98/14641 disclosed a square or rectangular combinatorial chemchip which features different deposit concentrations of species created by the differences in electrical potential among regions. The electroplating technology used in this patent is not widely applied due to the differences in conductivity and electric charge among compositions of different species.

Koinuma et al. disclosed a method for preparing a combinatorial chemchip in Physica Chem. 335:245-250, 2000. The method utilizes laser molecular bean epitaxy combined with a square mask to create combinatorial chemchip composed of different metal oxides. This technology focuses on the design and the preparation of a square mask.

U.S. Pat. No. 5,776,359, U.S. Pat. No. 5,985,356, U.S. Pat. No. 6,004,617, and U.S. Pat. No. 6,045,671 disclosed methods for preparing combinatorial chemchips, which utilize sputtering technology combined with square or rectangular masks.

The combinatorial chemchips prepared by existing technologies are all square or rectangle. These chips do not feature a systematic relationship between the compositions of species and the locations of sample materials. This makes screening more time consuming. Thus, it is necessary to develop a combinatorial chemchip which is able to coordinate the compositions of species therein.

### SUMMARY OF THE INVENTION

It is therefore a primary object of the present invention to provide a triangular combinatorial chemchip, which comprises a triangular sample space and a geometric array having 4ⁿ distinct congruent defined regions, wherein n is a natural number. Each defined region is provided with a single sample material of unique composition. The components of sample materials are selected from three different solid chemicals. The present invention features a systematic relationship between the locations of the 4ⁿ distinct defined regions and the compositions of sample materials contained therein. It is thus possible to screen compositions of mixtures comprehensively and systematically. Moreover, the results shown in contour lines are clearly recognizable. Therefore, the present invention is superior to the square or rectangular combinatorial chemchips of the prior art.

In one preferred embodiment, the present invention provides a triangular combinatorial chemchip comprising a large triangular sample set of compositions of mixed species, which comprises 4(4¹), 16(4²), 64(4³), or 256(4⁴) or more congruent distinct regions.

Another aspect of the present invention provides a method for preparing the triangular combinatorial chemchip having 4ⁿ distinct defined regions. The method comprises the steps of preparing (n²+n+2)/2 masks, wherein n is a natural number, each masks comprises a plurality of open portions and a plurality of covered portions, wherein each open portion has an opening; in sequence, placing each mask onto a substrate, and sputtering chemicals onto the masked substrate.

In one preferred embodiment, the present invention provides a method for preparing a triangular combinatorial chemchip having 16 distinct defined regions, wherein the method comprises the steps of preparing 4 masks, wherein each masks comprises a plurality of open portions and a plurality of covered portions, wherein each open portion has an opening; in sequence, placing each mask onto a substrate, and sputtering chemicals onto the masked substrate.

In another preferred embodiment, the present invention provides a method for preparing a triangular combinatorial chemchip having 64 distinct defined regions, wherein the method comprises the steps of preparing 7 masks, wherein each masks comprises a plurality of open portions and a plurality of covered portions, wherein each open portion has an opening; in sequence, placing each mask onto a substrate, and sputtering chemicals onto the masked substrate. The method for preparing a chip features wide utility and is superior to the prior art of electroplating which didn't utilize any mask.

### BRIEF DESCRIPTION OF THE DRAWINGS

The present invention will be more fully understood and further advantages will become apparent when reference is made to the following description of the invention and the accompanying drawings in which:

FIG. 1(A) and 1(B) are diagrams showing two triangular masks used herein for preparing a triangular combinatorial chemchip having 4 distinct defined regions.

FIG. 2 is a diagram showing a triangular chemchip having 4 distinct defined regions in the present invention; wherein reticular-spot region implies a layer of Co, solid-spot region implies a layer of Ni, and hollow-spot region implies a layer of Fe.

FIG. 3(A) to FIG. 3(D) are diagrams showing the open and covered portions of triangular masks used herein for preparing a triangular combinatorial chemchip having 16 distinct defined regions.

FIG. 4 is a diagram showing a triangular chemchip having 16 distinct defined regions in the present invention; wherein reticular-spot region implies a layer of Co, solid-spot region implies a layer of Ni, and hollow-spot region implies a layer of Fe.

FIG. 5(A) to FIG. 5(G) are diagrams showing the open and covered portions of triangular masks used herein for preparing a triangular combinatorial chemchip having 64 distinct defined regions.

FIG. 6 is a diagram showing a triangular chemchip having 64 distinct defined regions in the present invention; wherein reticular-spot region implies a layer of Co, solid-spot region implies a layer of Ni, and hollow-spot region implies a layer of Fe.

### DETAILED DESCRIPTION OF THE INVENTION

The present invention provides a method for preparing a triangular combinatorial chemchip, the method comprising the steps of preparing a triangular mask, placing the mask onto a substrate and sputtering onto the masked substrate to form a triangular combinatorial chemchip. The combinatorial chemchip in the present invention comprises a triangular sample space, and a geometric array contained therein having 4ⁿ distinct congruent defined regions, wherein n is a natural number. For example, when n=1, there are 4 distinct regions; when n=2, there are 16 distinct regions; when n=3, there are 64 distinct regions; and so on. Each defined region has only one sample material of unique composition, wherein the components of each sample material are selected from three different solid chemicals.

The triangular sample space is a substrate, for example, a metal, an alloy, a metallic oxide, a silicon wafer, a quartz, or a glass. The chemicals suitable for sputtering onto the sample space are not limited. Chemicals used for the triangular combinatorial chemchip in the present invention may be selected from three different chemicals, for example, metals or metallic compounds such as Fe, Co, Ni, indium oxide, etc. The shape of the defined region may be a triangle, a circle, a square, or a rhombus. The triangular combinatorial chemchip prepared by the method of the present invention features a systematic relationship between locations of 4ⁿ distinct defined regions and compositions or concentrations of sample materials contained therein.

The system of the present invention uses three sides of a triangle to arrange the sample materials. That is, each of the three apexes of a triangle represents a pure chemical, while each of the three sides of the triangle represents binary compositions, and the internal regions of the triangle represents tertiary compositions. Accordingly, the locations of the defined regions and the compositions of the sample materials contained therein are systematically arranged. Compared to the prior art of square or rectangular combinatorial chemchips which result in diffused expressions on the chips due to the non-systematic arrangement of sample materials, the coordinate-arranged triangular combinatorial chemchip in the present invention has a better visualization. It is easier to recognize effective compositions (or recipes) of sample materials by marking a contour line because those compositions will be close to each other.

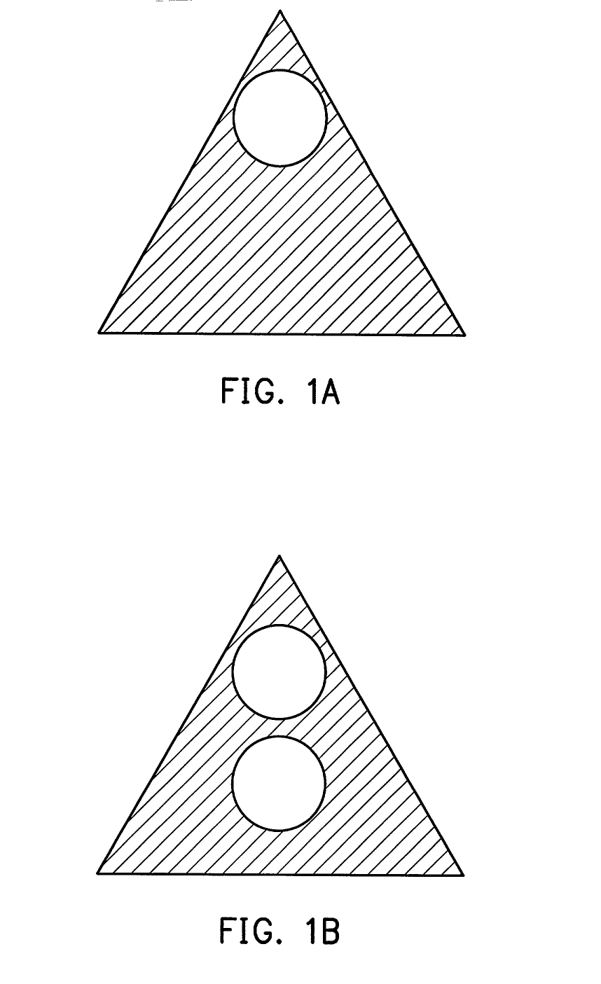

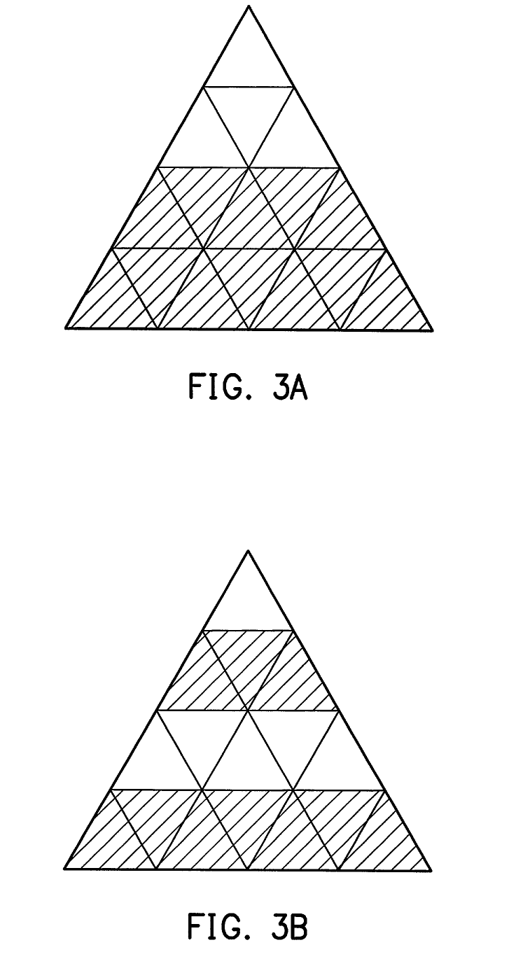

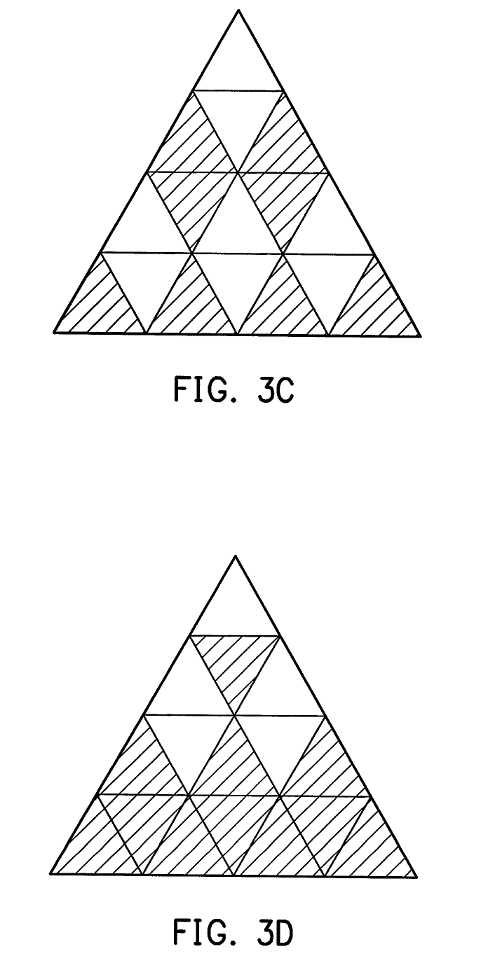

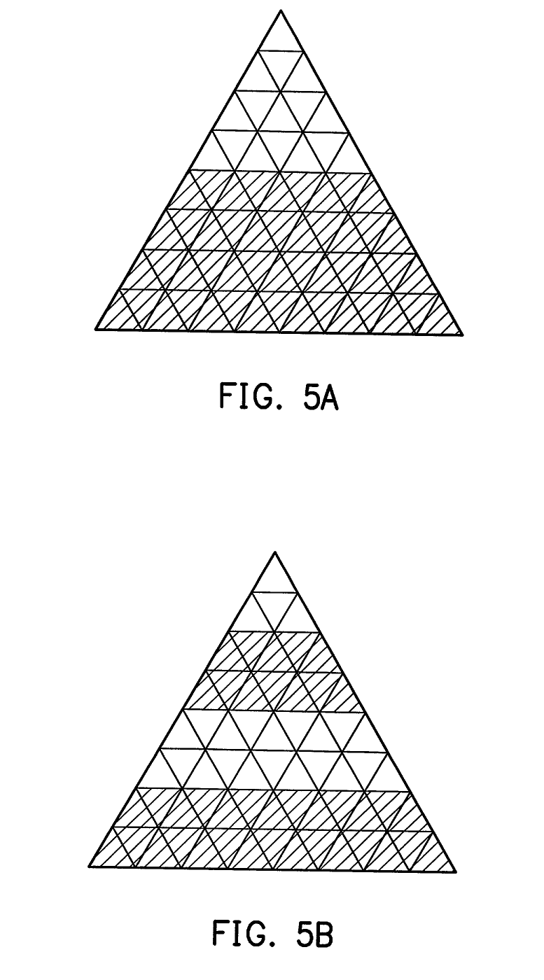

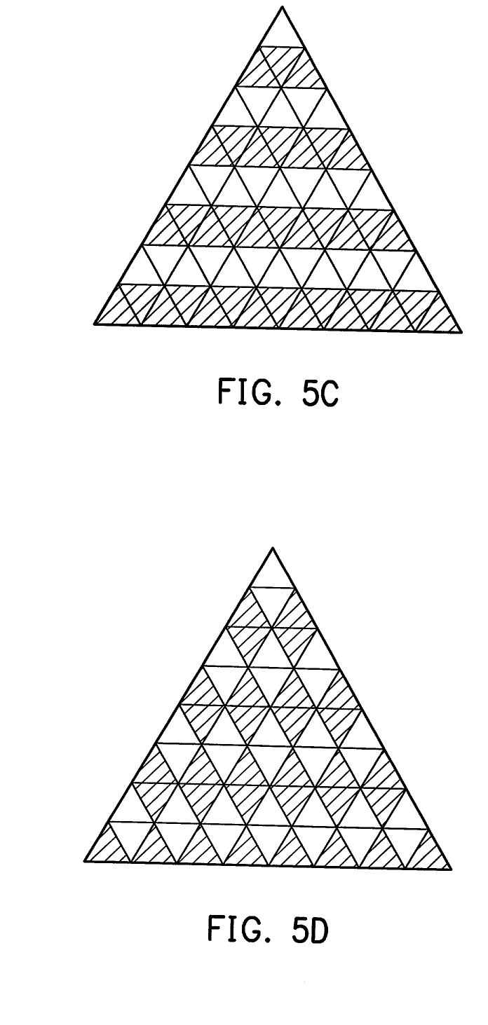

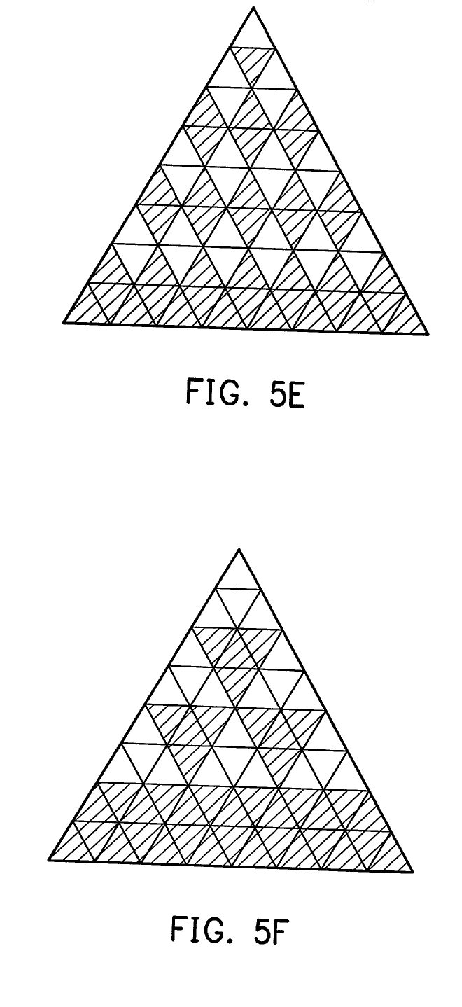

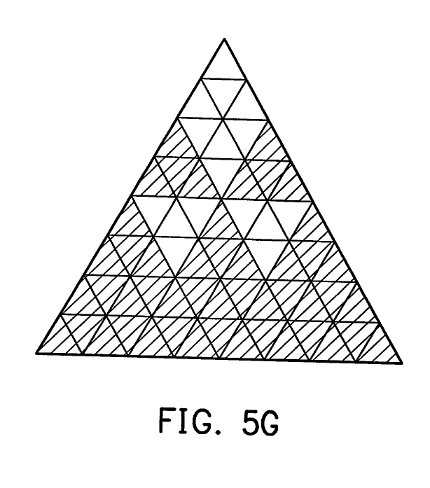

Preparation method of the combinatorial chemchip disclosed in the present invention includes several steps. First, a substrate is selected and pretreated as needed, for example, a silicon wafer immersed and washed with isopropyl alcohol, in order to enhance attachment of chemicals during sputtering. Second, taking a regular-triangular combinatorial chemchip as an example, (n²+n+2)/2 masks are prepared. Then one of such masks is placed and fixed on the pretreated substrate, and the first chemical (for example, Ni) is sputtered onto the masked substrate. After sputtering, this mask is rotated 120° (for example, counter-clockwise) and the second chemical (for example, Fe) is sputtered onto the masked substrate. After the second sputtering, the mask is rotated 120° again in the same direction, and the third chemical (for example, Co) is sputtered onto the masked substrate. In the same manner, next mask instead of the previous one is placed and fixed on the same substrate, and the identical sputtering procedure is performed. For example, a triangular combinatorial chemchip having 4 distinct regions can be obtained by utilizing 2 masks as shown in FIG. 1(A) and 1(B) to perform the sputtering steps set forth. A triangular combinatorial chemchip having 16 distinct regions can be obtained by utilizing 4 masks as shown in FIG. 3(A) to 3(D) to perform the sputtering steps set forth. A triangular combinatorial chemchip having 64 distinct regions can be obtained by utilizing 7 masks as shown in FIG. 5(A) to 5(G) to perform the sputtering steps set forth.

The direction for rotating masks can be counter-clockwise or clockwise, but the same mask has to be rotated in the same direction during one sputtering sequence. For instance, if a mask is rotated counter-clockwise after the first sputtering step, then it has to be rotated counter-clockwise after the remaining sputtering steps of the sequence. On the other hand, if a mask is rotated clockwise after the first sputtering step, it has to be rotated clockwise after the remaining sputtering steps of the sequence. The angle of rotation is also fixed. Preferably, the triangular combinatorial chemchip is a regular triangle. Thus the angle of rotation is 120° at each step. It is understood, however, that the triangle for the triangular combinatorial chemchip used in the present invention can be a regular triangle, an isosceles triangle or a right-angled triangle. Appropriate masks exposing and covering different portions of the substrate to create a systematic array of sample materials can be designed by those skilled in the art. The rotation of those irregular masks would be adjusted appropriately for matching the angles of the triangle.

Based on three sputtered chemicals and the coordinate arrangement thereof, one can easily screen sample materials composed of the three chemicals using the triangular combinatorial chemchip of the present invention. This triangular combinatorial chemchip can be applied to high throughput screening of solid mixtures with different compositions.

Without intending to limit it in any manner, the present invention will be further illustrated by the following examples.

### EXAMPLE

### Example 1

### Preparation of Triangular Combinatorial Chemchip Having 4 Distinct Regions

Two triangular masks with different patterns were used as shown in FIG. 1(A) and 1(B). A silicon wafer was chosen as the substrate. The wafer was immersed in isopropyl alcohol for 10 min, and vacuum-dried to enhance metal attachment. The first mask as shown in FIG. 1(A) was placed on the pretreated substrate, and the substrate was sputtered with Ni. After Ni sputtering, the first mask was rotated 120° counter-clockwise, and the substrate was sputtered with Fe. After Fe sputtering, the first mask was again rotated 120° counter-clockwise, and the substrate was sputtered with Co.

Similarly, the second mask as shown in FIG. 1(B) was then placed onto the substrate, and the substrate was sputtered with Ni. After Ni sputtering, the second mask was rotated 120° counter-clockwise, and the substrate was sputtered with Fe. After Fe sputtering, the second mask was again rotated 120° counter-clockwise, and the substrate was sputtered with Co.

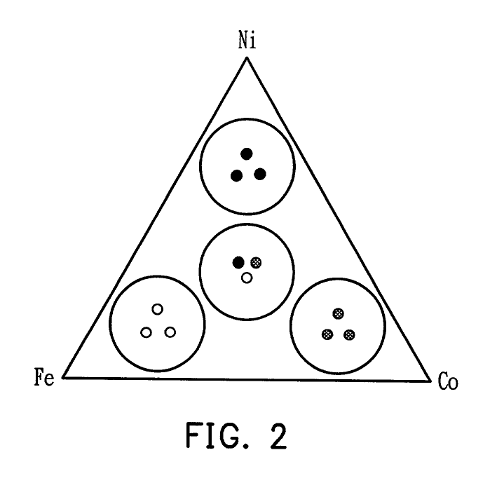

As a consequence, the triangular combinatorial chemchip having 4 distinct regions was obtained, as shown in FIG. 2.

### Example 2

### Preparation of Triangular Combinatorial Chemchip Having 16 Distinct Regions

Four triangular masks with different patterns of open and covered portions were used as shown in FIG. 3(A) to 3(D). A silicon wafer was chosen as the substrate. The wafer was pretreated as described in Example 1 to enhance metal attachment. The first mask, as shown in FIG. 3(A), was placed on the pretreated substrate, and the substrate was sputtered with Ni. After Ni sputtering, the first mask was rotated 120° counter-clockwise, and the substrate was sputtered with Fe. After Fe sputtering, the first mask was rotated 120° counter-clockwise, and the substrate was sputtered with Co.

Similarly, the second mask as shown in FIG. 3(B) was then placed onto the substrate, and the substrate was sputtered with Ni. After Ni sputtering, the second mask was rotated 120° counter-clockwise, and the substrate was sputtered with Fe. After Fe sputtering, the second mask was rotated 120° counter-clockwise, and the substrate was sputtered with Co.

The third mask as shown in FIG. 3(C) was then placed onto the substrate, and the substrate was sputtered with Ni. After Ni sputtering, the third mask was rotated 120° counter-clockwise, and the substrate was sputtered with Fe. After Fe sputtering, the third mask was rotated 120° counter-clockwise, and the substrate was sputtered with Co.

Finally, the fourth mask as shown in FIG. 3(D) was then placed onto the substrate, and the substrate was sputtered with Ni. After Ni sputtering, the fourth mask was rotated 120° counter-clockwise, and the substrate was sputtered with Fe. After Fe sputtering, the fourth mask was rotated 120° counter-clockwise, and the substrate was sputtered with Co.

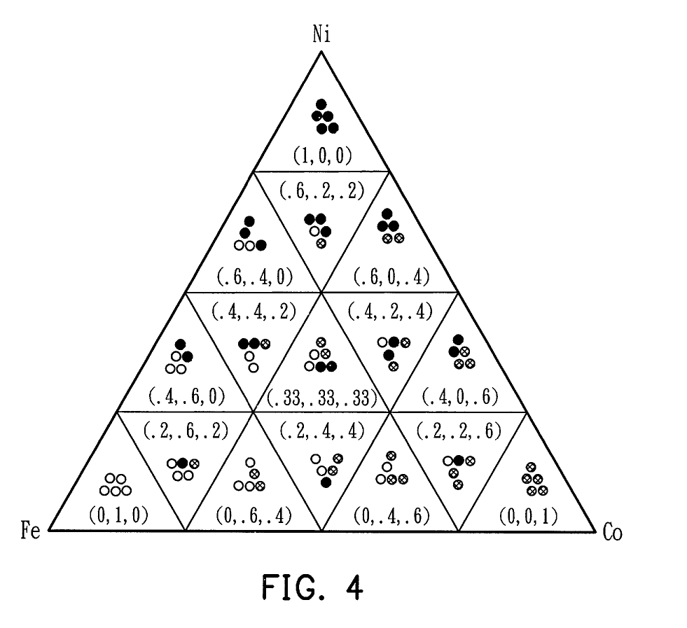

As a consequence, the triangular combinatorial chemchip having 16 distinct regions was obtained, as shown in FIG. 4.

### Example 3

### Preparation of Triangular Combinatorial Chemchip Having 64 Distinct Regions

Seven triangular masks with different patterns of open and covered portions were used as shown in FIG. 5(A) to 5(G). A silicon wafer was chosen as the substrate. The wafer was pretreated as described in Example 1 to enhance metal attachment. The first mask as shown in FIG. 5(A) was placed on the pretreated substrate, and the substrate was sputtered with Ni. After Ni sputtering, the first mask was rotated 120° counter-clockwise, and the substrate was sputtered with Fe. After Fe sputtering, the first mask was rotated 120° counter-clockwise, and the substrate was sputtered with Co.

Similarly, the second mask as shown in FIG. 5(B) was then placed onto the substrate, and the substrate was sputtered with Ni. After Ni sputtering, the second mask was rotated 120° counter-clockwise, and the substrate was sputtered with Fe. After Fe sputtering, the second mask was rotated 120° counter-clockwise, and the substrate was sputtered with Co.

The third mask as shown in FIG. 5(C) was then placed onto the substrate, and the substrate was sputtered with Ni. After Ni sputtering, the third mask was rotated 120° counter-clockwise, and the substrate was sputtered with Fe. After Fe sputtering, the third mask was rotated 120° counter-clockwise, and the substrate was sputtered with Co.

The fourth mask as shown in FIG. 5(D) was then placed onto the substrate, and the substrate was sputtered with Ni. After Ni sputtering, the fourth mask was rotated 120° counter-clockwise, and the substrate was sputtered with Fe. After Fe sputtering, the fourth mask was rotated 120° counter-clockwise, and the substrate was sputtered with Co.

The fifth mask as shown in FIG. 5(E) was then placed onto the substrate, and the substrate was sputtered with Ni. After Ni sputtering, the fifth mask was rotated 120° counter-clockwise, and the substrate was sputtered with Fe. After Fe sputtering, the fifth mask was rotated 120° counter-clockwise, and the substrate was sputtered with Co.

The sixth mask as shown in FIG. 5(F) was then placed onto the substrate, and the substrate was sputtered with Ni. After Ni sputtering, the sixth mask was rotated 120° counter-clockwise, and the substrate was sputtered with Fe. After Fe sputtering, the sixth mask was rotated 120° counter-clockwise, and the substrate was sputtered with Co.

Finally, the seventh mask as shown in FIG. 5(G) was then placed onto the substrate, and the substrate was sputtered with Ni. After Ni sputtering, the seventh mask was rotated 120° counter-clockwise, and the substrate was sputtered with Fe. After Fe sputtering, the seventh mask was rotated 120° counter-clockwise, and the substrate was sputtered with Co.

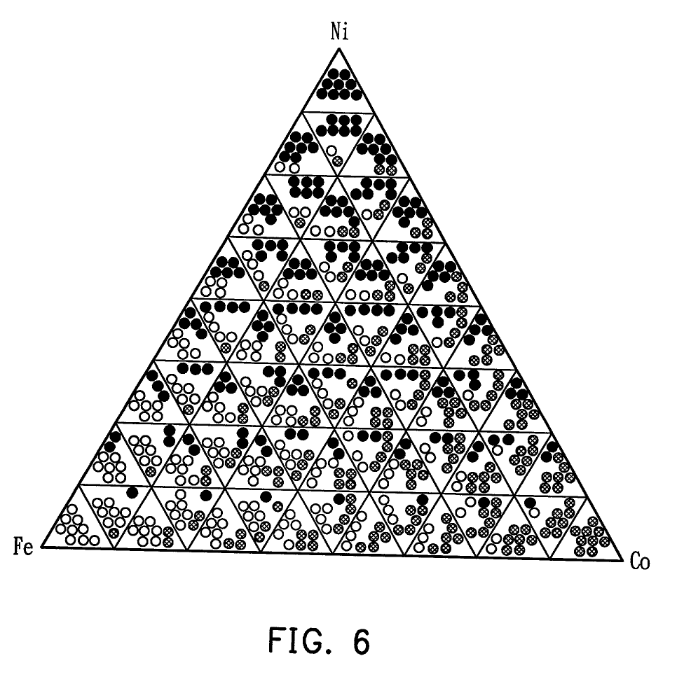

As a consequence, the triangular combinatorial chemchip having 64 distinct regions was obtained, as shown in FIG. 6.

While the invention has been particularly shown and described with the reference to the preferred embodiment thereof, it will be understood by those skilled in the art that various changes in form and details may be made without departing from the spirit and scope of the invention.

What is claimed is:

1. A triangular combinatorial chemchip, comprising a triangular sample space and a geometric array including 4ⁿ distinct congruent defined regions thereof, wherein n is a natural number, each defined region is provided with a single sample material of unique composition selected from three different solid chemicals, and the relationship between the location of a defined regions and the composition at that region is systematically coordinated, wherein each of the three apexes of such a triangular chemchip consists of a pure chemical, each of the three sides of the triangular chemchip consists of binary compositions, and the internal regions of the triangular chemchip consist of tertiary compositions.

2. The triangular combinatorial chemchip as claimed in claim 1, wherein the sample space is a substrate selected from a metal, an alloy, a metallic oxide, a silicon wafer, a quartz and a glass.

3. The triangular combinatorial chemchip as claimed in claim 1, wherein the triangle of the triangular sample space is a regular triangle, an isosceles triangle, or a right-angled triangle.

4. The triangular combinatorial chemchip as claimed in claim 1, wherein the solid chemicals are metals or metallic compounds.

5. The triangular combinatorial chemchip as claimed in claim 1, wherein the shape of the defined region is a triangle, a circle, a square, or a rhombus.

6. The triangular combinatorial chemchip as claimed in claim 1, wherein n is 1, 2, 3, 4, 5 or 6.

7. A method for preparing a regular triangular combinatorial chemchip consisting of 4ⁿ distinct regions, comprising the steps of:
preparing (n²+n+2)/2 masks, each mask comprising a plurality of open portions and a plurality of covered portions; and
in sequence, placing each mask onto the substrate, sputtering a first chemical onto the masked substrate, rotating the mask with a direction of a defined angle, sputtering a second chemical onto the masked substrate, rotating the mask with the same direction of the defined angle, sputtering a third chemical onto the masked substrate.

8. The method as claimed in claim 7, wherein the substrate is a metal, an alloy, a metallic oxide, a silicon wafer, a quartz, or a glass.

9. The method as claimed in claim 7, wherein the rotating direction is clockwise or counter-clockwise.

10. The method as claimed in claim 7, wherein the defined angle is 120°.

11. The method as claimed in claim 7, wherein the chemicals are metals or metallic compounds.

12. The method as claimed in claim 7, wherein the shape of the open portions is a regular triangle, a circle, a square, or a rhombus.

13. The method as claimed in claim 7, further comprising the step of pre-treating the substrate to enhance chemical attachment during sputtering.

14. The method as claimed in claim 7, wherein n is 1, 2, 3, 4, 5 or 6.
